(19) United States
(12) Patent Application Publication
(10) Pub. No.: US 2024/0075637 A1
(43) Pub. Date: Mar. 7, 2024

(54) JOINT STRUCTURE AND ROBOT

(71) Applicant: FANUC CORPORATION, Yamanashi (JP)

(72) Inventor: Kouhei HANATANI, Yamanashi (JP)

(21) Appl. No.: 18/270,153

(22) PCT Filed: Jan. 21, 2022
(86) PCT No.: PCT/JP2022/002115

§ 371 Date: Jun. 28, 2023

(30) Foreign Application Priority Data
Jan. 27, 2021 (JP) 2021-010881

(51) Int. Cl. B25J 17/00

(52) U.S. Cl. CPC B25J 17/00

(57) ABSTRACT

A joint structure includes: a first member having a cylindrical first inner surface extending along a predetermined axis; a second member having a cylindrical outer surface disposed coaxially with the first inner surface; a first seal that seals annular gap between the first inner surface and the outer surface while allowing relative rotation of the first member and the second member about the axis; a third member having a second inner surface disposed coaxially with the first inner surface and detachably attached to the first member on an outer side of a sealing position sealed with the first seal; and a second seal that is press-fitted into the second inner surface and that seals annular gap between the second inner surface and the outer surface while allowing relative rotation of the first member and the second member about the axis.

### CROSS-REFERENCE TO RELATED APPLICATION(S)

This is a National Stage Entry into the United States Patent and Trademark Office from International Patent Application No. PCT/JP2022/002115, filed on Jan. 21, 2022, which relies on and claims priority to Japanese Patent Application No. 2021-010881, filed on Jan. 27, 2021, the entire contents of which both of which are incorporated herein by reference.

### FIELD OF THE INVENTION

The present disclosure relates to a joint structure and a robot.

### BACKGROUND OF THE INVENTION

A robot including a joint portion including a first wall member accommodating a power transmission mechanism and lubricant therein and a second wall member supported so as to be rotatable about a predetermined rotation axis with respect to the first wall member has been disclosed (for example, see Japanese Unexamined Patent Application, Publication No. 2009-107116).

A contact seal element is disposed between the first wall member and the second wall member to seal a gap therebetween. Furthermore, between the first wall member and the second wall member, on the outer side of the contact seal element, a second seal portion for sealing a gap therebetween is disposed. The second seal portion is press-fitted to the outer circumferential surface of the first wall member by a press machine.

### SUMMARY OF THE INVENTION

According to an aspect of the present disclosure, there is provided a joint structure including: a first member having a cylindrical first inner surface extending along a predetermined axis; a second member having a cylindrical outer surface disposed coaxially with the first inner surface; a first seal that seals an annular gap between the first inner surface and the outer surface while allowing relative rotation of the first member and the second member about the axis; a third member having a second inner surface disposed coaxially with the first inner surface and detachably attached to the first member on an outer side of a sealing position with the first seal; and a second seal that is press-fitted into the second inner surface and that seals an annular gap between the second inner surface and the outer surface while allowing relative rotation of the first member and the second member about the axis.

### BRIEF DESCRIPTION OF THE DRAWINGS

FIG. 1 shows the overall configuration of a robot according to an embodiment of the present disclosure.

FIG. 2 is a vertical cross-section illustrating an example of a joint structure according to the embodiment of the present disclosure, provided in the robot in FIG. 1.

FIG. 3 is a partial enlarged vertical cross-section for explaining an oil seal at the joint structure in FIG. 2.

FIG. 4 is a front view of a first detachable member of the joint structure in FIG. 2, as viewed from a sixth axis direction.

FIG. 5 is an exploded vertical cross-section of the joint structure in FIG. 2.

FIG. 6 is a vertical cross-section showing a modification of the joint structure in FIG. 2.

FIG. 7 is an exploded vertical cross-section of the joint structure in FIG. 6.

FIG. 8 is a vertical cross-section showing another modification of the joint structure in FIG. 2.

### DESCRIPTION OF EMBODIMENT(S) OF THE INVENTION

A joint structure 10 and a robot 1 according to an embodiment of the present disclosure will be described below with reference to the drawings.

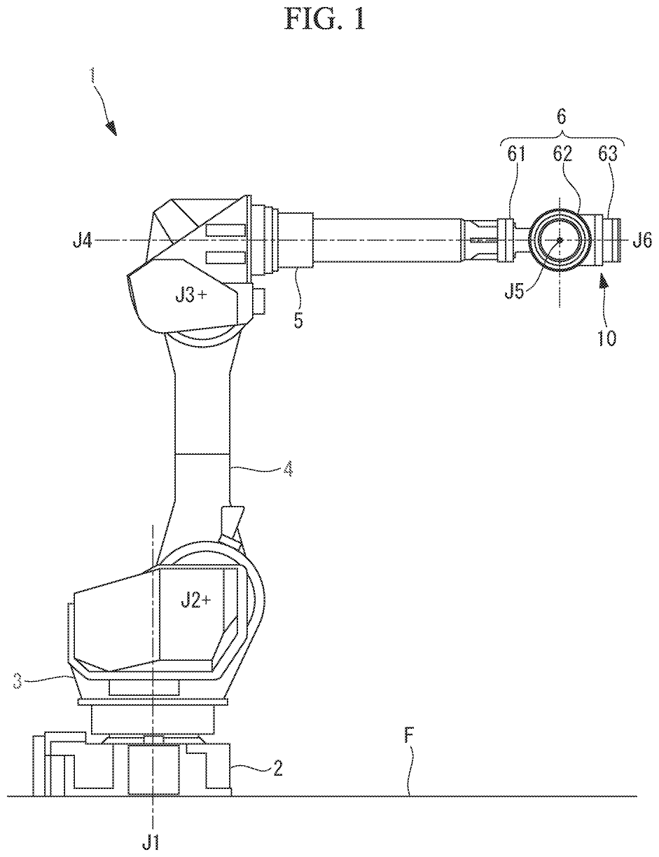

The robot 1 with the joint structure 10 according to this embodiment is, for example, a vertical six-axis articulated type robot, as illustrated in FIG. 1.

The robot 1 includes a base 2 installed on a horizontal floor F, and a turning body 3 supported so as to be rotatable about a vertical first axis J1 with respect to the base 2. The robot 1 also includes a first arm 4 that is supported so as to be rotatable about a horizontal second axis J2 with respect to the turning body 3, and a second arm 5 that is rotatable about a horizontal third axis J3 with respect to the first arm 4.

The robot 1 also includes a three-axis wrist unit 6 at the distal end of the second arm 5. The wrist unit 6 includes a first wrist element 61 supported so as to be rotatable about a fourth axis J4, which extends along a plane orthogonal to the third axis J3, with respect to the second arm 5. The wrist unit 6 also includes a second wrist element 62 supported so as to be rotatable about a fifth axis J5, which is orthogonal to the fourth axis J4, with respect to the first wrist element 61. The wrist unit 6 also includes a third wrist element 63 supported so as to be rotatable about a sixth axis (axis) J6, which is orthogonal to the fifth axis J5 and passes through the intersection between the fourth axis J4 and the fifth axis J5, with respect to the second wrist element 62.

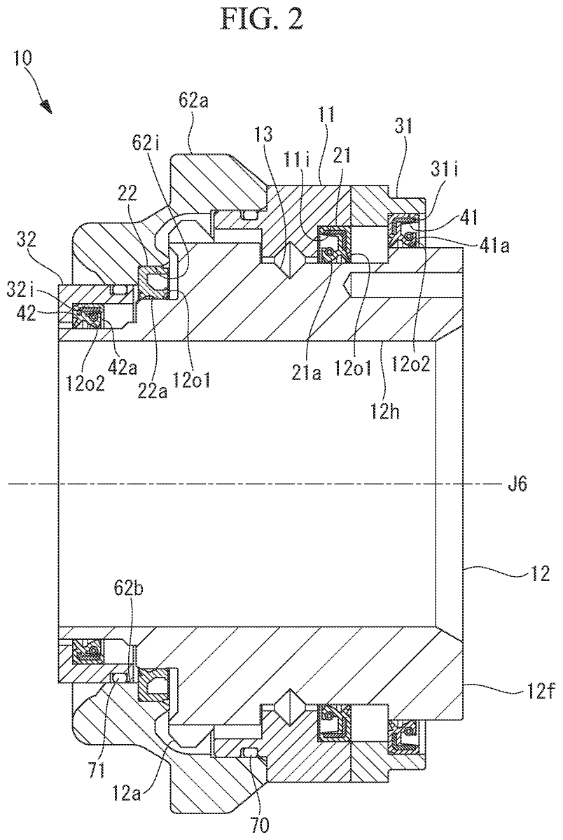

The joint structure 10 according to this embodiment is configured such that, for example, the third wrist element 63 is rotationally driven with respect to the second wrist element 62. As shown in FIG. 2, the joint structure 10 includes: a housing (first member) 62a of the second wrist element 62, and an annular fixed member (first member) 11 fixed to the housing 62a; and a movable member (second member) 12 disposed inside the housing 62a and the fixed member 11.

As a result of the fixed member 11 constituting an outer ring, the movable member 12 constituting an inner ring, and, for example, rollers 13 being disposed between the fixed member 11 and the movable member 12, a bearing is formed, so that the movable member 12 is supported so as to be rotatable about the sixth axis J6 with respect to the fixed member 11.

The joint structure 10 also includes an oil seal (first seal) 21 disposed between the fixed member 11 and the movable member 12, and an oil seal (first seal) 22 disposed between the housing 62a and the movable member 12.

The joint structure 10 also includes a first detachable member (third member) 31 detachably fixed to an end of the fixed member 11, and a second detachable member (third member) 32 detachably fixed to an end of the housing 62a. The joint structure 10 also includes an oil seal (second seal) 41 disposed between the first detachable member 31 and the movable member 12, and an oil seal (second seal) 42 disposed between the second detachable member 32 and the movable member 12.

The fixed member 11 and the housing 62a have cylindrical inner circumferential surfaces (first inner surfaces) 11i and 62i, respectively, centered on the sixth axis J6. Furthermore, the fixed member 11 and the housing 62a are fixed in a sealed state with an O-ring 70 interposed therebetween.

The movable member 12 is formed in a cylindrical shape having a through-hole 12h centered on the sixth axis J6. The movable member 12 has two outer circumferential surfaces (outer surfaces) 12o1 disposed at positions radially inward of the inner circumferential surfaces 11i and 62i of the fixed member 11 and the housing 62a with gaps therebetween so as to face the inner circumferential surfaces 11i and 62i. The movable member 12 also has two outer circumferential surfaces (outer surfaces) 12o2 coaxial with the outer circumferential surfaces 12o1. The outer circumferential surfaces 12o2 are disposed on both sides of the two outer circumferential surfaces 12o1 in the direction of the sixth axis J6.

The movable member 12 is provided with a flange surface 12f to which a tool (not shown), such as a hand, is to be attached, at one end in the direction of the sixth axis J6.

The movable member 12 is also provided with a driven gear 12a that meshes with a drive gear (not shown). When the drive gear is rotated, the rotational force is transmitted to the movable member 12 via the driven gear 12a to rotate the movable member 12 about the sixth axis J6 with respect to the fixed member 11 and the housing 62a.

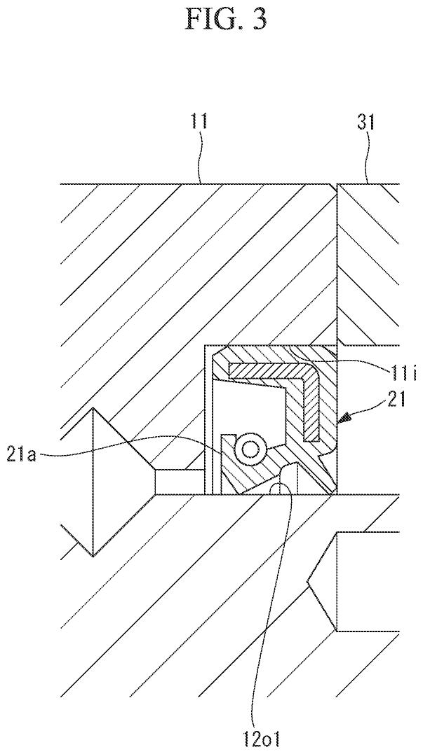

As shown in FIGS. 2 and 3, the oil seal 21 has an annular lip portion 21a on the radially inner side and is press-fitted into the inner circumferential surface 11i of a step portion provided in the fixed member 11. Similarly, the oil seal 22 has an annular lip portion 22a on the radially inner side and is press-fitted into the inner circumferential surface 62i of a step portion provided in the housing 62a. The lip portions 21a and 22a are in contact with the overall outer circumferential surfaces 12o1 of the movable member 12.

When the movable member 12 is rotated about the sixth axis J6 with respect to the fixed member 11 and the housing 62a, the outer circumferential surfaces 12o1, while being kept in contact with the lip portions 21a and 22a of the oil seals 21 and 22, move in the circumferential direction. This way, even when the movable member 12 rotates, the gap between the movable member 12, and the fixed member 11 and the housing 62a is sealed by the oil seals 21 and 22.

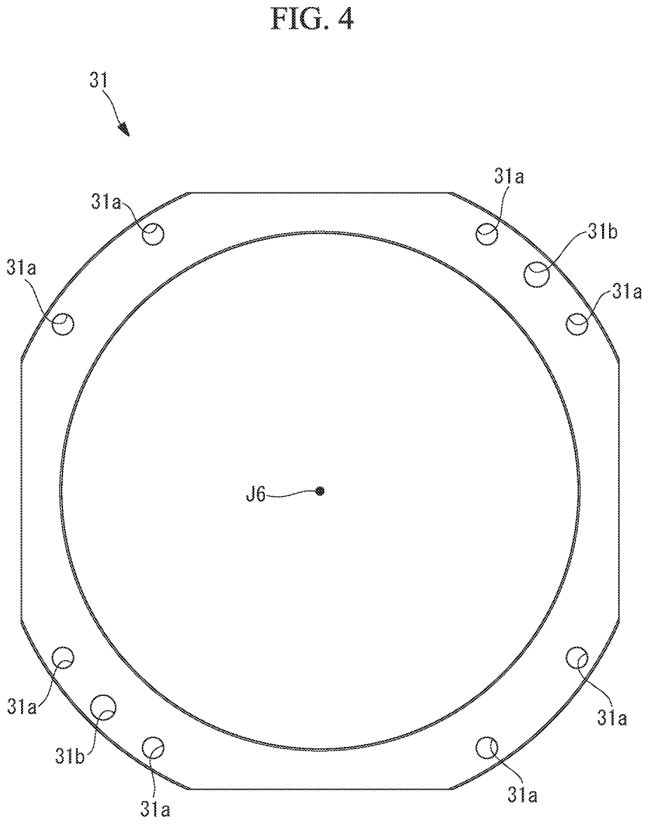

As shown in FIG. 2, the first detachable member 31 has a cylindrical inner circumferential surface (second inner surface) 31i disposed coaxially with the inner circumferential surface 11i of the fixed member 11 and disposed radially outward of the outer circumferential surface 12o2 of the movable member 12 with a gap therebetween. As shown in FIG. 4, the first detachable member 31 has multiple through-holes 31a and two pin holes 31b parallel to the sixth axis J6, which is the central axis.

The first detachable member 31 is detachably fixed to one end of the fixed member 11 by fastening bolts (not shown) inserted through the through-holes 31a into screw holes (not shown) provided in the fixed member 11. Furthermore, the first detachable member 31 is radially positioned with respect to the fixed member 11 by inserting pins (not shown) inserted through the two pin holes 31b into pin holes (not shown) provided in the fixed member 11.

The second detachable member 32 has a cylindrical inner circumferential surface (second inner surface) 32i disposed coaxially with the inner circumferential surface 62i of the housing 62a and disposed radially outward of the outer circumferential surface 12o2 of the movable member 12 with a gap therebetween. Similarly to the first detachable member 31, the second detachable member 32 has multiple through-holes (not shown) and is detachably fixed to one end of the housing 62a by fastening bolts (not shown) inserted through the through-holes into screw holes (not shown) provided in the housing 62a. Positioning of the second detachable member 32 in the radial direction with respect to the housing 62a is performed by fitting the second detachable member 32 to a fitting surface 62b of the housing 62a.

A sealing member (not shown), such as a gasket, forms a seal between the first detachable member 31 and the fixed member 11. An O-ring 71 interposed between the second detachable member 32 and the housing 62a forms a seal therebetween.

As shown in FIG. 2, the oil seals 41 and 42 have annular lip portions 41a and 42a, respectively, on the radially inner side thereof and are press-fitted into the inner circumferential surfaces 31i and 32i of the first detachable member 31 and the second detachable member 32, respectively. As a result of the first detachable member 31 and the second detachable member 32 being fixed to the end of the fixed member 11 or the end of the housing 62a, the lip portions 41a and 42a come into contact with the overall outer circumferential surfaces 12o2, on the outer sides of the sealing positions with the oil seals 21 and 22.

When the movable member 12 is rotated about the sixth axis J6 with respect to the fixed member 11 and the housing 62a, the outer circumferential surfaces 12o2 move in the circumferential direction while being kept in contact with the lip portions 41a and 42a of the oil seals 41 and 42. In this way, even when the movable member 12 rotates, the gaps between the inner circumferential surfaces 31i and 32i of the first detachable member 31 and the second detachable member 32 and the outer circumferential surfaces 12o2 of the movable member 12 are sealed by the oil seals 41 and 42.

In this embodiment, the maximum diameters of the movable member 12 on the outer sides of the sealing positions sealed with the oil seals 41 and 42 are set to be smaller than or equal to the outer diameters of the outer circumferential surfaces 12o2 of the movable member 12 at the sealing positions sealed with the oil seals 41 and 42. By doing so, when the oil seal 41 is removed to the flange surface 12f side or fitted onto the outer circumferential surface 12o2 from the flange surface 12f side, the lip portion 41a does not interfere with other members. Furthermore, similarly to the oil seal 41, when the oil seal 42 is attached or detached, the lip portion 42a does not interfere with other members.

The operation of the thus-configured joint structure 10 according to this embodiment will be described below.

With the joint structure 10 according to this embodiment, the space between the oil seals 21 and 22 is maintained in a sealed state by the two oil seals 21 and 22 disposed in the gap between the movable member 12, and the fixed member 11 and the housing 62a. Accordingly, it is possible to rotate the movable member 12 about the sixth axis J6 with respect to the fixed member 11 and the housing 62a, while preventing lubricant, such as grease, filled in the aforementioned space to lubricate the roller 13, the drive gear, the driven gear 12a, and the like from leaking out of the space.

In addition, the oil seal 41 that seals the gap between the first detachable member 31 and the movable member 12 on the outer side of the sealing position with the oil seal 21 reduces the opportunities for external dust or the like to reach the oil seal 21, and thus, it is possible to protect the oil seal 21.

When the oil seal 41 exposed to the outside is damaged by external dust or the like, the oil seal 41 can be replaced to recover the sealing performance.

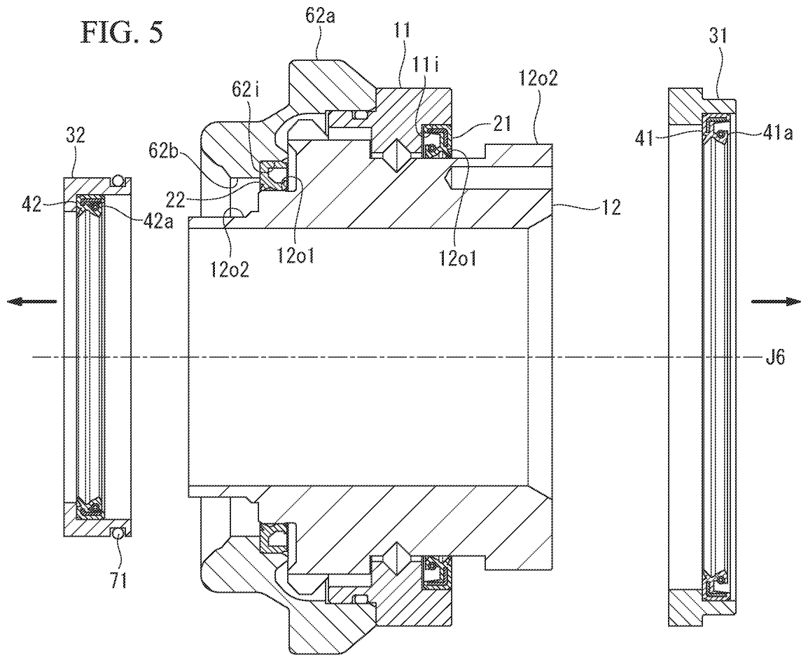

When the oil seal 41 is to be replaced, the bolts fixing together the fixed member 11 and the first detachable member 31 are removed, and the first detachable member 31, together with the oil seal 41, is removed from the fixed member 11 toward the flange surface 12f side, in the direction of the sixth axis J6, as shown in FIG. 5. Then, the removed first detachable member 31 and oil seal 41 are replaced with a new first detachable member 31 and oil seal 41, and the new first detachable member 31 and oil seal 41 are returned to the originally attached positions from the flange surface 12f side to complete the task of replacing the oil seal 41.

In this case, because the maximum diameter of the movable member 12 on the outer side of the sealing position with the oil seal 41 is smaller than or equal to the outer diameter of the outer circumferential surface 12o2, the oil seal 41 can be easily attached to and detached from the outer circumferential surface 12o2 without damaging the lip portion 41a of the oil seal 41.

Because the first detachable member 31 and the oil seal 41 are removed without removing the oil seal 21, the space filled with the lubricant can be maintained in a sealed state. Thus, it is possible to easily perform the task of replacing the oil seal 41 in a short time without allowing the lubricant to be discharged out of the space.

As described above, with the joint structure 10 according to this embodiment, the oil seal 41 can be easily removed from the wrist unit 6 simply by removing the first detachable member 31 from the fixed member 11 and can be easily attached without using a press machine or the like at the site.

Hence, there is no need to remove the wrist unit 6 from the robot 1, to move the robot 1 itself to the place where a press machine is located, or to bring the press machine to the site, and the task of replacing the oil seal 41 can be facilitated.

As shown in FIG. 5, the oil seal 42 can also be easily replaced by removing the second detachable member 32 from the housing 62a to the side opposite to the flange surface 12f, in the same manner as the oil seal 41.

When the first detachable member 31 or the second detachable member 32 detached from the wrist unit 6 is not damaged and can be reused, the oil seal 41 or 42 is removed from the first detachable member 31 or the second detachable member 32 by using a tool. Then, a new oil seal 41 or 42 is press-fitted into the first detachable member 31 or the second detachable member 32, from which the oil seal 41 or 42 has been removed, by using a press machine.

Because the first detachable member 31 or the second detachable member 32 detached from the wrist unit 6 can be transported relatively easily, the first detachable member 31 or the second detachable member 32 may be brought to a place where the press machine is installed.

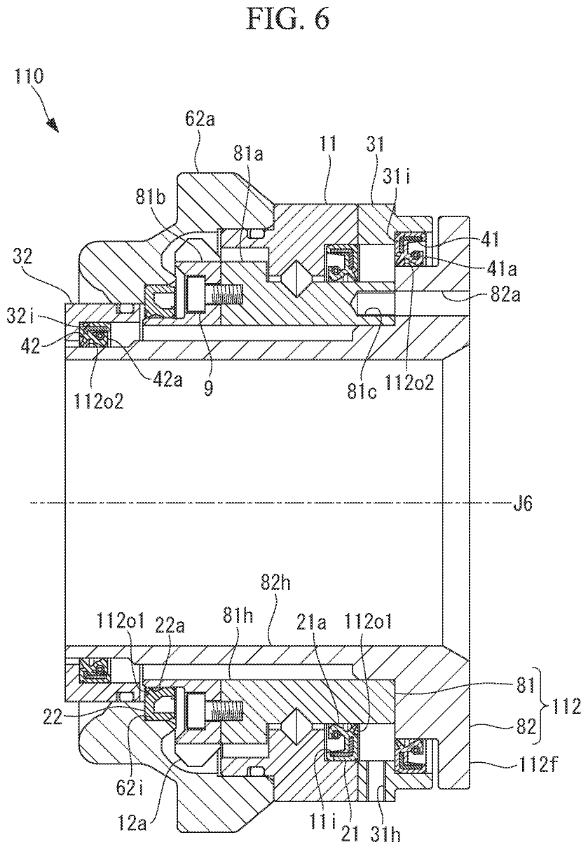

Although the movable member 12 is formed of a single member in this embodiment, instead, a movable member (second member) 112 formed of two or more members may be employed, as shown in FIG. 6.

In a joint structure 110 shown in FIG. 6, the movable member 112 includes a cylindrical hollow member 81 provided with a through-hole 81h penetrating in a direction along the sixth axis J6, and a penetrating member 82 detachably attached to the hollow member 81 in a state of penetrating through the through-hole 81h.

As shown in FIG. 6, the hollow member 81 may be an integral member formed by fastening, with bolts 9, a main body 81a constituting the inner ring of the bearing and a gear member 81b provided with a driven gear 12a.

The hollow member 81 has two outer circumferential surfaces (outer surfaces) 112o1, with the overall circumferences of which the lip portions 21a and 22a of the oil seals 21 and 22 are in contact. The hollow member 81 is provided with, at one end thereof, multiple screw holes 81c at intervals in the circumferential direction.

The penetrating member 82 is formed in a cylindrical shape having a through-hole 82h centered on the sixth axis J6. The penetrating member 82 has two outer circumferential surfaces (outer surfaces) 112o2, with the overall circumferences of which the lip portions 41a and 42a of the oil seals 41 and 42 are in contact. As shown in FIG. 6, a flange surface 112f protruding further radially outward in a flange shape than the outer circumferential surface 112o2 is provided at one end of the penetrating member 82. The flange surface 112f is provided with multiple through-holes 82a at intervals in the circumferential direction.

As shown in FIG. 6, the hollow member 81 and the penetrating member 82 are arranged coaxially by fitting the penetrating member 82 into the through-hole 81h of the hollow member 81, and are fixed together by fastening bolts (not shown), inserted through the through-holes 82a, into the screw holes 81c.

When the joint structure 110 is to be assembled, in a state in which the first detachable member 31 and the second detachable member 32, into which the oil seals 41 and 42 are press-fitted, are fixed to the fixed member 11 and the housing 62a, respectively, the penetrating member 82 is inserted into the through-hole 81h and fixed to the hollow member 81. When the penetrating member 82 is inserted into the through-hole 81h, the two outer circumferential surfaces 112o2 provided on the penetrating member 82 are fitted to the inner sides of the lip portions 41a and 42a of the oil seals 41 and 42. The flange surface 112f provided on the penetrating member 82 is disposed at a position covering the oil seal 41.

According to the thus-configured joint structure 110, because the oil seal 41, which is likely to receive scattered dust or the like from the tool side, is covered and protected by the flange surface 112f, the durability of the oil seal 41 can be improved, which is advantageous. When the oil seal 41 is to be replaced, first, the penetrating member 82 is removed from the hollow member 81, and then the first detachable member 31 is removed from the fixed member 11.

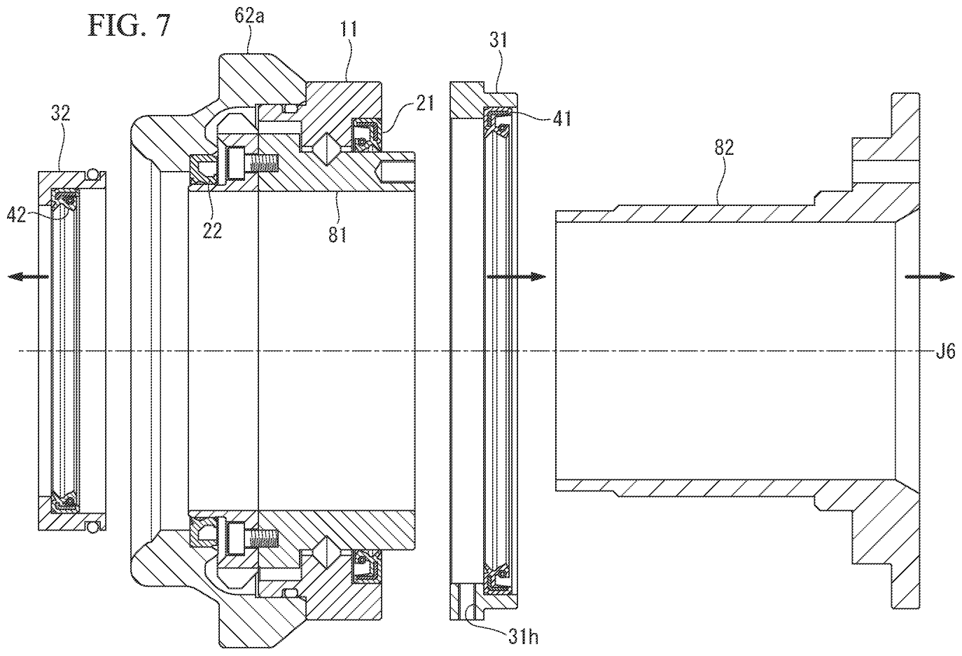

Also in this case, as shown in FIG. 7, there is no need to remove the hollow member 81. Hence, it is possible to easily replace the oil seal 41 alone, without allowing the lubricant to be discharged. The oil seal 42 can be easily replaced by removing the second detachable member 32 from the housing 62a, without removing the penetrating member 82.

Note that when the oil seals 41 and 42 are damaged by dust or the like, the two outer circumferential surfaces 112o2, which are in contact with the lip portions 41a and 42a, may also be damaged by biting due to dust or the like. In such a case, the joint structure 110 is advantageous in that the penetrating member 82 having the two outer circumferential surfaces 112o2 can also be easily replaced without allowing the lubricant to be discharged.

Furthermore, in the joint structure 110, a member including the hollow member 81 having the through-hole 81h and the penetrating member 82 that can be easily attached to and detached from the hollow member 81 is employed as the movable member 112, and the hollow member 81 and the penetrating member 82 are fixed together in a state in which the penetrating member 82 penetrates through the through-hole 81h in the hollow member 81. With this configuration, the two outer circumferential surfaces 112o2, which are disposed on both sides of the oil seals 21 and 22 in the direction of the sixth axis J6, can be provided on the single penetrating member 82, not on individual members, which is advantageous in that the component count is reduced.

In this embodiment, as shown in FIG. 6, a through-hole (observation window) 31h penetrating in the radial direction may be provided in the sidewall of the first detachable member 31 located between the oil seal 21 and the oil seal 41. The through-hole 31h may be closed by a window member (not shown) made of a transparent material or may be closed by a detachable plug (not shown).

This allows an operator to observe the state of the space between the oil seals 21 and 41 from the outside through the through-hole 31h and, if the entry of dust or the like into the space is confirmed, it can be determined that the sealing property of the oil seal 41 is deteriorated. Specifically, by checking the state of the space sealed by the oil seals 21 and 41 regularly or as necessary, the oil seal 41 can be replaced before the oil seal 21 is damaged.

When the side surface of the fixed member 11 extends to a position between the oil seal 21 and the oil seal 41, the through-hole 31h may be provided in the fixed member 11. Instead of forming the observation window of the through-hole 31h, the observation window may be formed of a cutaway portion provided in at least one of the fixed member 11 and the first detachable member 31 in the joint surface between the fixed member 11 and the first detachable member 31.

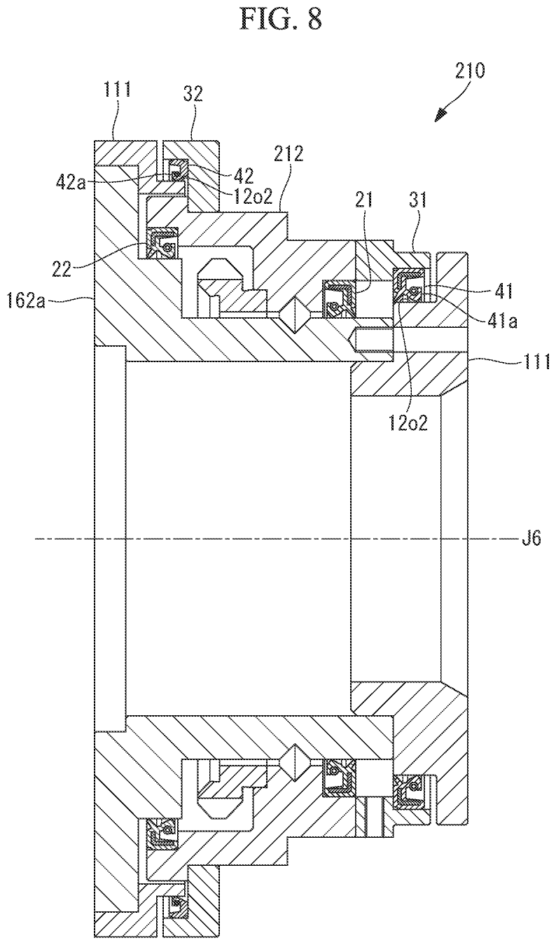

In this embodiment, the movable member 12 is disposed inside the housing 62a and the fixed member 11 so as to be rotatable about the sixth axis J6. Alternatively, as shown in FIG. 8, a movable member (first member) 212 may be disposed outside a housing (second member) 162a. In the example shown in FIG. 8, fixed members (second members) 111 are detachably attached to the ends of the housing 162a in the direction of the sixth axis J6.

In a joint structure 210 shown in FIG. 8, the fixed members 111 are each provided with the outer circumferential surface 12o2 with which the lip portion 41a or 42a of the oil seal 41 or 42 comes into contact. The first detachable member 31 and the second detachable member 32 are detachably attached to the ends of the movable member 212.

When the oil seal 41 is to be replaced, the oil seal 41 can be easily replaced in the same manner as described above by removing the fixed member 111 from the housing 162a and then removing the first detachable member 31 from the movable member 212. When the oil seal 42 is to be replaced, the oil seal 42 can be easily replaced in the same manner as described above simply by removing the second detachable member 32 from the movable member 212.

Furthermore, in this embodiment, although the case where the oil seals 41 and 42 are disposed on both outer sides of the sealing positions with the pair of oil seals 21 and 22 has been described, instead of this, it may be applied to a case where the housing 62a has a bag-like structure in which the housing 62a is open only in one direction. In this case, for example, the oil seal 41 may be disposed on the outer side of the sealing position with a single oil seal 21, and the oil seal 41 may be detachably attached with the first detachable member 31.

Although the joint structure 10 between the second wrist element 62 and the third wrist element 63 has been described as an example in this embodiment, it is not limited thereto and may be applied to a joint structure or the like at any other position.

1. A joint structure comprising:
a first member having a cylindrical first inner surface extending along a predetermined axis;
a second member having a cylindrical outer surface disposed coaxially with the first inner surface;
a first seal that seals an annular gap between the first inner surface and the outer surface while allowing relative rotation of the first member and the second member about the axis;
a third member having a second inner surface disposed coaxially with the first inner surface and detachably attached to the first member on an outer side of a sealing position sealed with the first seal; and
a second seal that is press-fitted into the second inner surface and that seals an annular gap between the second inner surface and the outer surface while allowing relative rotation of the first member and the second member about the axis.

2. The joint structure according to claim 1, wherein
the first seal is disposed at each of two ends of the first member in a direction of the axis, at a position where the annular gap between the first inner surface and the outer surface is sealed, and
each of the second seal and the third member is disposed on the outer side of the sealing position sealed with the first seal.

3. The joint structure according to claim 2, wherein
the second member includes a hollow member having a through-hole penetrating in a direction along the axis, and a penetrating member detachably fixed to the hollow member in a state of penetrating through the through-hole,
the outer surface on which the first seal slides is provided on the hollow member, and
the outer surface on which the second seal slides is provided on the penetrating member.

4. The joint structure according to claim 1, further comprising an observation window through which a state in a gap between the first member and the second member between the first seal and the second seal disposed on the outer side of the sealing position with the first seal can be observed from outside.

5. The joint structure according to claim 1, wherein a maximum diameter of the second member on an outer side of a sealing position sealed with the second seal is smaller than or equal to a diameter of the outer surface on which the second seal slides.

6. A robot comprising the joint structure according to claim 1.
